(19) United States
(12) Patent Application Publication
(10) Pub. No.: US 2026/0149653 A1
(43) Pub. Date: May 28, 2026

(54) REMOTE RADIO HEAD UNIT HIGH HEAT FUNCTIONALITY TESTING APPARATUS AND METHOD FOR THE SAME

(71) Applicant: Communications Test Design, Inc., West Chester, PA (US)

(72) Inventors: Paul CASALE, Springfield, PA (US); Tim PHILIPOSIAN, West Chester, PA (US); Pratik PASALKAR, West Chester, PA (US); Christopher WILSON, Newark, DE (US); John GOLDMAN, Elverson, PA (US)

(73) Assignee: Communications Test Design, Inc., West Chester, PA (US)

(21) Appl. No.: 18/956,070

(22) Filed: Nov. 22, 2024

(51) Int. Cl. H04L 43/50; G01M 99/00

(52) U.S. Cl. CPC H04L 43/50; G01M 99/008

(57) ABSTRACT

An apparatus and method for high heat functionality testing of a remote radio head unit is shown and described. The apparatus includes a chamber having a door and a plurality of walls creating an interior volume. At least two vents attached to the chamber such that air can enter and exit the chamber. A computer operably coupled to an apparatus system. A thermometer secured within the chamber which is operably coupled to the computer via the apparatus system. At least one fan secured to at least one of the vents. Each of the at least one fan is operably coupled to the computer via the apparatus system. A plurality of electrical and network connections to allow for a remote radio head unit to be operably coupled to the electrical connections and receive proper power and to be operably coupled to the computer via the apparatus system through the network connections.

### BACKGROUND OF THE INVENTION

Technology is always advancing and has done so at a rapid pace for the last several decades. Technology has become sophisticated, smaller, and accessible across the globe. This has led to technology becoming integral in everyday life. As with any integral element of life, the demand is high. This high demand has led to a rise in the cost of technological devices.

In addition to high demand, the simple replacement of devices can be expensive. If one merely discards older equipment or equipment with minor defects for a brand-new piece the cost can escalate quickly. If, however, technology is upgraded, or repaired this process can be much more cost effective for both the company and consumer.

With the rise of handheld and portable electronic devices the need for connectivity has risen. This means that companies need to supply more connections points or remote radio head units. These radio heads can become extremely expensive to constantly have to install new. However, with some testing and repair the life a radio head can be significantly extended. These radio heads can be taken down for maintenance and reinstalled. This creates cost savings and a quicker turn around time allowing companies to install more radio heads much quicker.

Many companies have been taking advantage of the repair instead of discard philosophy. Further, many consumers are happy purchasing a lightly used and repaired device instead of a brand new one. However, these processes come with new challenges in order to remain effective. Consequently, there is always a need for an improvement in the art.

### SUMMARY OF THE INVENTION

The present invention provides a remote radio head unit high heat functionality testing apparatus and method for the same wherein the same can be utilized for ensuring proper functionality of a remote radio head unit from a testing facility. The apparatus for high heat testing of a remote radio head unit includes a chamber comprised of at least one door and a plurality of walls creating an interior volume. At least two vents are attached to the chamber such that air can enter and exit the interior volume of the chamber. A computer is operably coupled to an apparatus system. A thermometer is secured within the chamber. The thermometer is operably coupled to the computer via the apparatus system. At least one fan is secured to at least one of the vents. Each of the at least one fans are operably coupled to the computer via the apparatus system. A plurality of electrical connections and a plurality of network connections are housed in the chamber.

Another object of remote radio head unit high heat functionality testing apparatus is to have at least one latch secured to the door and at least one wall of the chamber.

Another object of remote radio head unit high heat functionality testing apparatus is to have a control panel secured to the chamber. The control panel is operably coupled to the computer via the apparatus system.

Another object of remote radio head unit high heat functionality testing apparatus is to have the control panel include at least one item selected from the group consisting of: a power button, a start button, a clock, a temperature display, and a plurality of lights.

Another object of remote radio head unit high heat functionality testing apparatus is to have a screen secured to a wall of the chamber and operably coupled with the computer.

Another object of remote radio head unit high heat functionality testing apparatus is to have a shelf located within the chamber.

Another object of remote radio head unit high heat functionality testing apparatus is to have the shelf have a plurality of apertures therethrough.

Another object of remote radio head unit high heat functionality testing apparatus is to have the shelf be secured to a bracket which allows the shelf to be partially removed from the chamber without being disconnected from the chamber.

Another object of remote radio head unit high heat functionality testing apparatus is to have a door sensor operably coupled to the computer via the apparatus system. The door sensor determines when the door is in an open position.

Another object of remote radio head unit high heat functionality testing apparatus is to have the plurality of electrical connections allow for a remote radio head unit to be operably coupled to the electrical connections and receive proper power

Another object of remote radio head unit high heat functionality testing apparatus is to have the plurality of network connections allow for a remote radio head unit to be operably coupled to the computer via the apparatus system through the network connections.

Other objects, features and advantages of the present invention will become apparent from the following detailed description taken in conjunction with the accompanying drawings.

### BRIEF DESCRIPTION OF THE DRAWINGS

The accompanying drawings are incorporated in and are to be considered part of the present specification. These drawings are meant to aid the reader's understanding and comprehension of the present disclosure and are depictions of various example embodiments. The drawings are not to be considered limiting upon the disclosure. It should specifically be noted that the drawings are examples and may not necessarily be drawn to scale.

FIG. 1 shows a block diagram of a computing system.

FIG. 2 shows an example of a remote radio head unit.

FIG. 3A shows a front perspective view of an embodiment of the apparatus for testing a remote radio head unit.

FIG. 3B shows a rear perspective view of an embodiment of the apparatus for testing a remote radio head unit.

FIG. 4 shows a perspective view of an embodiment of the interior of the apparatus for testing a remote radio head unit.

FIG. 5 shows a flow chart of an embodiment of a method for high heat functionality testing of a remote radio head unit.

### DETAILED DESCRIPTION OF THE INVENTION

For the purposes of presenting a brief and clear description of the present invention, a preferred embodiment will be discussed as used for the remote radio head unit high heat functionality testing apparatus and method for the same. The figures are intended for representative purposes only and should not be considered to be limiting in any respect.

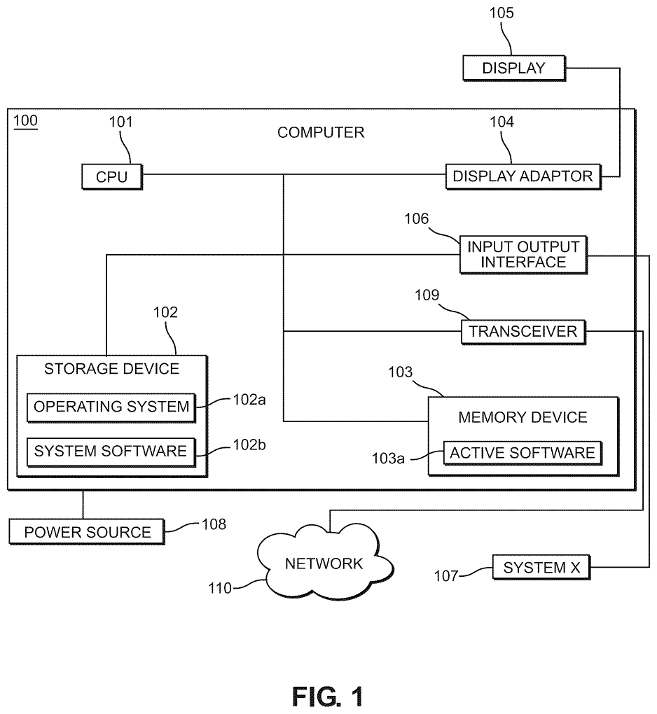

Referring now to FIG. 1, there is shown a block diagram of a computing system. Computing systems may have many interchangeable parts or multiples of some parts. One of ordinary skill in the art will understand that the shown computer 100 is a basic computing system demonstrating a minimal amount of parts to allow for the computer to function. Computer 100 is exemplary, and one of ordinary skill in the art will recognize that computer 100 may be altered as necessary to render the presently disclosed system operable or to provide a peak performance of the disclosed system.

The parts described are each operably coupled together as necessary, one of ordinary skill in the art will understand how to connect general computer components, for example by use of a mother board or other computer board. In the shown embodiment the computer 100 includes a CPU 101. In one embodiment the CPU 101 includes only one processor. In other embodiments the CPU 101 may be made up of multiple processors. Different processors will allow for different computing power and speed.

The computer 100 includes at least one storage device 102. In different embodiments the at least one storage device 102 may be a solid-state storage device, a disk storage device, or another suitable storage device. One of ordinary skill in the art will recognize that there are several types of computing storage devices each providing well-known benefits and drawbacks. The at least one storage device 102 will store at least the computer operating system 102a and system software 102b. System software 102b may include any software necessary, or optionally, used to run any system described herein.

The computer 100 will have at least one memory device 103. One of ordinary skill in the art will recognize that there are several types of computing memory devices each providing well known benefits and drawbacks. The at least one memory device 103 will store at any active software 103a. Active software 103a may include the operating system 102a or parts of the system software 102b. The at least one memory device 103 may store the entire system software 102b size and speed permitting.

The computer 100 may also include various connection ports and types. The computer 100 may have a display adaptor 104. The display adaptor 104 will allow the computer 100 to connect to at least one display 105. In other embodiments multiple displays may be connected to the display adaptor 104. Similarly, the computer 100 may include at least one input/output interface 106. The input/output interface 106 will allow the computer 100 to connect to at least one system, referred to as System X or the apparatus system 107 in FIG. 1. The input/output interface 106 may also allow for connection to only part of System X 107 or multiple systems. The computer 100 will also be operably connected to a required power source 108.

The computer 100 may also include a transceiver 109. In one embodiment the transceiver 109 is a wired transceiver. In another embodiment the transceiver 109 is a wireless transceiver. The transceiver 109 will allow the computer 100 to connect to a network 110. The network 110 may be an internet or an intranet connection. The network 110 will allow for the computer 100 to potentially connect to multiple other computing devices. In another embodiment the network may allow for the computer 100 to connect to multiple systems. In one embodiment the computer 100 will allow for System X 107 to be connected to the network 110.

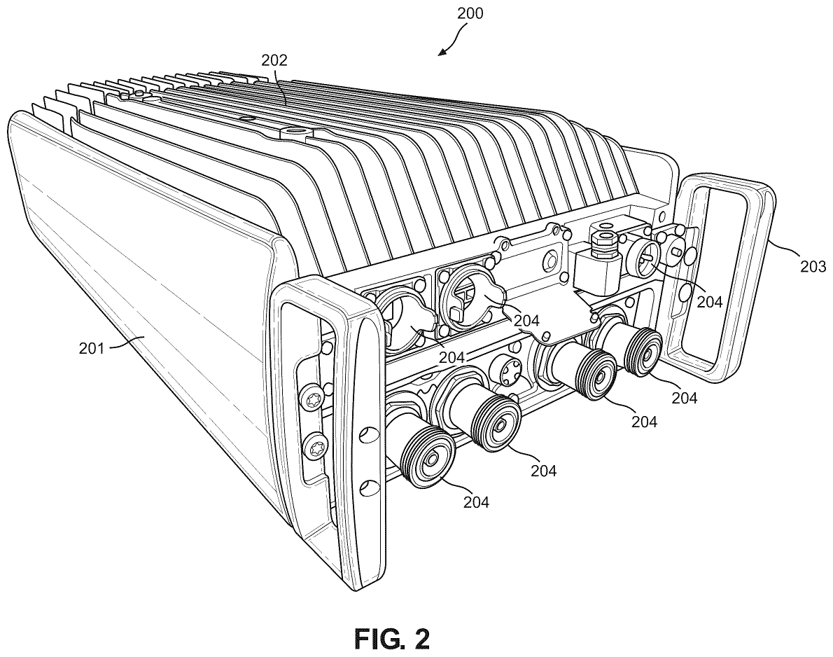

Referring now to FIG. 2, there is shown an example of a remote radio head unit. The shown remote radio head unit 200 is only an example or a radio head unit. There are many different models of radio heads produced by many different companies and manufacturers. Each one may have slight differences or different features. However, each remote radio head unit 200 will have at least several similar components in common.

Remote radio head unit 200 includes a housing 201 which contains at least some of the electronic components required. For example, but not shown, the remote radio head unit 200 may include a computer as described in FIG. 1. The computer will be connected to at least one radio antenna which may be capable of receiving or transmitting (or both) radio signals. In addition the housing 201 may include a heat reduction device 202 secured at least in part to the electronic components. In many remote radio head units 200 the heat reduction device 202 is a heatsink using fins. As air passes over the heatsink the device will be cooled. This prevents the use of cooling fans which can break more often, causing the need for additional repairs.

In some embodiments the housing 201 can include at least one handle 203. In one embodiment the handle can be used to lift the device. In another embodiment a special connector is used in order to lift the device. In some embodiments handles may double as connection protection. This will prevent the connections as described below from being damaged.

The remote radio head unit 200 includes several different electronical connections 204. The electrical connections 204 include power connections. These power connections will allow for the device to receive power. The electrical connections further include information connections, such as fiber optic connections. These information connections allow for mobile data to be sent and received from the remote radio head unit 200. Each of these types of connections may include different types of connectors or cables. However, the purposes described herein are required for the functionality of the remote radio head unit 200.

In different embodiments different additional connections may be present such as connectors to allow for the connection of a field test device. In some embodiments status lights are included with the remote radio head unit 200. These lights can allow for an individual to readily determine status of the unit without the need to connect a device.

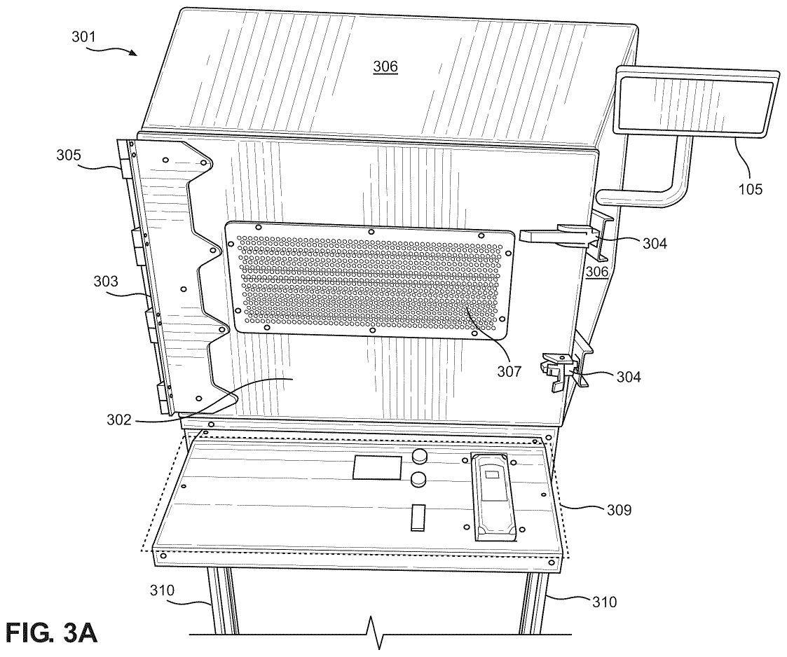

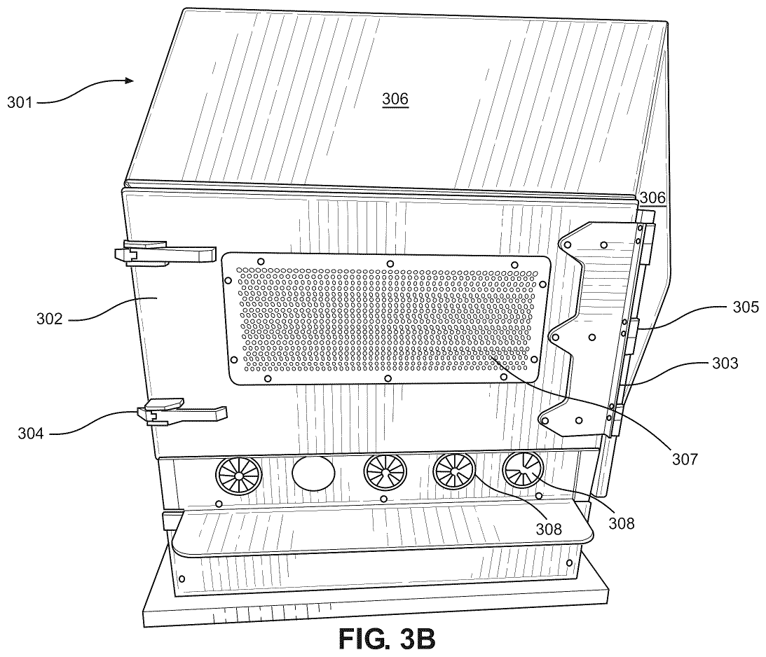

Referring now to FIG. 3A and FIG. 3B, there is shown a front perspective view and a rear perspective view, respectively, of an embodiment of the apparatus for testing a remote radio head unit. The testing apparatus includes a chamber 301. The chamber 301 includes at least one door 302. In the shown embodiment there is a door 302 located on both the front and rear of the chamber 302. The door 302 is secured to at least one side of the chamber 301. The at least one door 302 includes at least one hinge 303 along one side in order to allow the at least one door 302 to be open. The at least one door 302 also includes at least one latch 304. The at least one latch 304 will secure the at least one door 302 in a closed position. In some embodiments the at least one door includes at least one bumper 305 along the at least one hinge 303. The at least one bumper 305 will prevent the at least one door from swinging open and smashing into the chamber 301.

The chamber 301 also includes a plurality of walls 306 creating an interior volume. A plurality of vents 307 are secured to the at least one door 302 and/or the plurality of walls 306. The vents 307 allow air to access and be released from the interior volume of the chamber 301. In the shown embodiment the vents 307 are shown one the at least one door 302 in both the front and rear of the chamber 301.

In addition to the plurality of vents 307 the chamber 301 also includes a plurality of wire gaskets 308. The wire gaskets will allow for wires to pass through the gaskets and access the interior volume of the chamber 301.

In some embodiments various items are secured to the chamber 301. In the shown in one embodiment the chamber 301 is supported above the ground and therefore components can be placed below the chamber 301. For example, but not limited to, the computer components, system controls, and power supplies, can be stored below the chamber 301. In the shown embodiment a control panel 309 is secured to a frame 310 supporting the chamber 301. The control panel 309 may have various items thereon, for example, a power button, a start button, a clock, a temperature display, and a plurality of lights. In another embodiment the control panel 309 is supplemented with or replaced by a keyboard or other form of input device.

In some embodiments the display 105 is secured to the chamber 301. In some embodiments the display 105 doubles as a human machine interface, for example a touch screen. This will allow for a user to input various types of information into the computer and system.

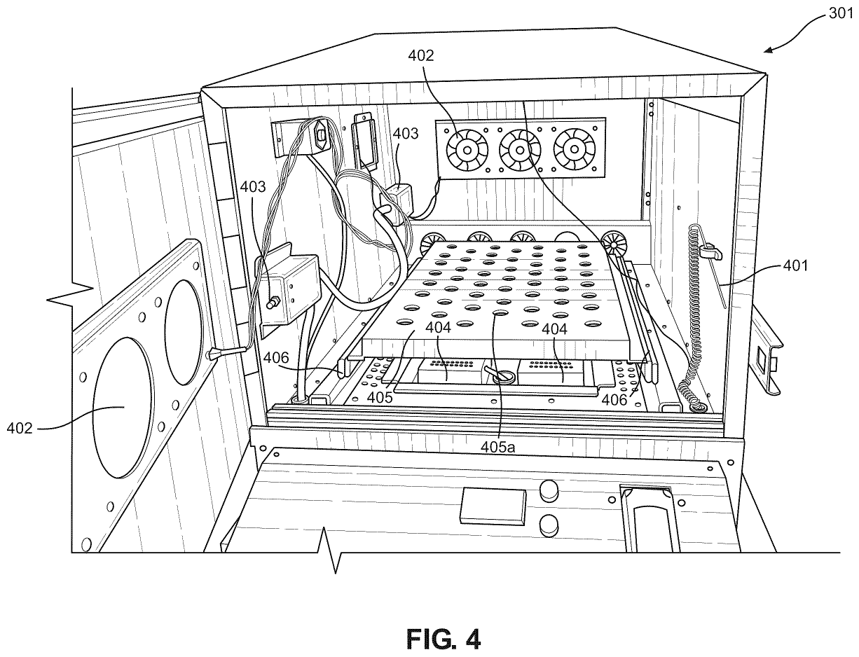

Referring now to FIG. 4, there is shown a perspective view of an embodiment of the interior of the apparatus for testing a remote radio head unit. The interior of the chamber 301 includes several sensors and other components allowing the apparatus to record and conduct a reliable test. At least one thermometer 401 is provided. The at least one thermometer 401 can be placed on or within a remote radio head in order to gather the temperature of the radio head through the test period. In some embodiments additional thermometers can record the internal temperature of the chamber 301 or can be used to record several different temperatures of the remote radio head.

At least one exhaust fan 402 is included. The at least one exhaust fan 402 will move air through the chamber 301. The at least one exhaust fan 402 will move air through the chamber 301. In one embodiment there is an intake exhaust fan and an exit exhaust fan, each part of the at least one exhaust fan 402. The exhaust fans 402 will help to better circulate air through the chamber and quickly cause a cooling effect, as will be better described below.

In some embodiments at least one door sensor 403 is used. The at least one door sensor 403 is used to determine if the door is correctly closed. A door sensor 403 is important to ensure that the chamber 301 remains closed throughout the testing phase. This creates a uniform test environment to better ensure no false test readings are recorded.

Various connections 404 are supplied within the chamber 301 which will allow for a remote radio head to be properly connected and operated. In the shown embodiment the connections are shown as general connections. However, one of ordinary skill in the art will understand what data and power supply connections and cables are necessary to attached any given remote radio head to the system. Further, the system is configured such that various configurations for specific remote radio heads and the necessary connections can be included. This includes testing parameters and running parameters which can be stored in the non-transitory storage medium (the memory device or storage device) of the computer.

In one embodiment a shelf 405 is built into the chamber 301. The shelf 405 will keep the remote radio head from crushing components. In some embodiments the shelf 405 has a plurality of apertures 405a therein. These apertures 405a will allow for better airflow to cross the remote radio head. In some embodiments the shelf 405 is configured to be moved in and out of the chamber 301. In one embodiment the shelf 405 is secured to a bracket 406 which will support the weight of a remote radio head. This will allow for the shelf 405 to be pull out of the chamber 301, the remote radio head can then be placed on the shelf 405 and the shelf can be returned to the interior of the chamber 301. This will prevent a user from having to place the remote radio head direction into the chamber 301.

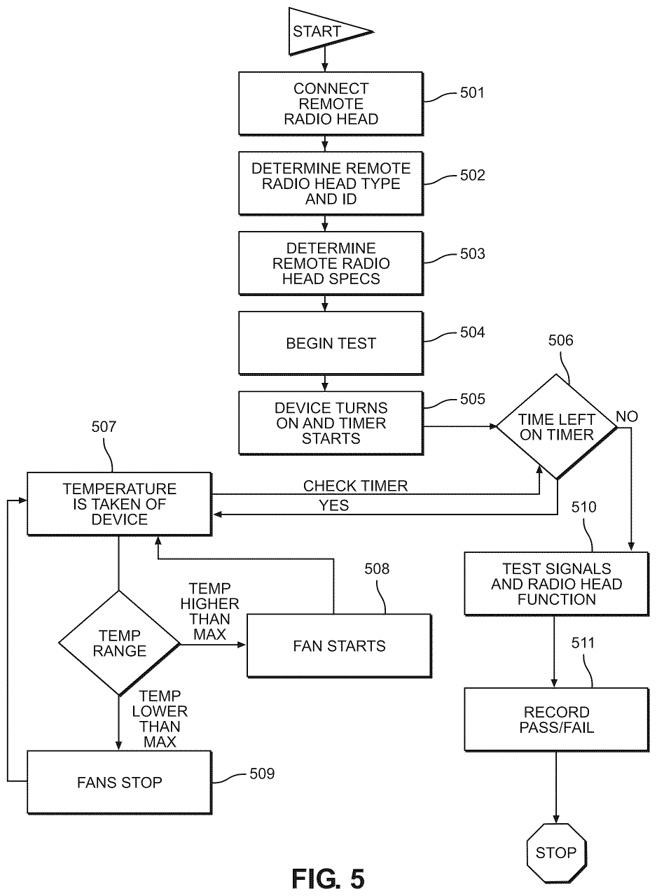

Referring now to FIG. 5, there is shown a flow chart of an embodiment of a method for high heat functionality testing of a remote radio head unit. The method of testing a remote radio head unit for heat tolerance begins by connecting the remote radio head to the system 501. This includes connecting data wires and power cables such that the remote radio head is capable of powering on and communicating with at least one computer or electronic device. Once connected the system will determine the type of remote radio head and the ID 502. For example, the system will determine the brand and model of the remote radio head. Further, the system will determine the serial number of the remote radio head.

After the brand and model is determined the specifications for the remote radio head can be determined 503. Each remote radio head may have different heat tolerances or communication expectations. It is important for these specifications to be accounted for during the testing. Once the test system is properly prepared and the proper specifications are accounted for, the test may begin 504. In one embodiment this means a user interacts with the system to start the test.

Once the test begins, a timer is started 505. Many of the heat specifications for remote radio heads include a maximum heat over a specific amount of time requirement. Therefore, both must be properly measured for an accurate test. At the same instance the timer is started the remote radio head is activated and is fully functional 505. After the time and remote radio head are activated the test system enters a loop.

The loop askes if there is time left on the timer 506. If time is left a temperature of the remote radio head is taken 507. If the temperature of the remote radio head is above a predetermined temperature max then the exhaust fans are started (or remain on) 508. If the temperature is below the temperature max the fans are turned off (or remain off) 509. After the fans are adjusted the timer is checked again. If no time is left then the signals of the remote radio head and the functionalities are tested 510. The results are recorded as pass or fail results 511 and the test is stopped. The results will tell if the remote radio head still functions after the heating stress test. In one embodiment the signal and functionality tests can be performed through the testing process such that if a fail is recorded the test can be stopped early and the issue addressed. This will save time by not waiting till the end of the heat test to determine pass or fail.

It is therefore submitted that the methods, systems, and devices have been shown and described in what is considered the most practical and preferred embodiments along with specific examples. It is recognized, however, that departures may be made within the scope and these present examples are not intended to be limiting. One of ordinary skill the art will be able to discern that obvious modifications can be made without departing from the scope or spirit.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, it is to be realized that, it is not intended for any method set forth herein to be construed as requiring that its steps be performed in a specific order, unless otherwise set forth in the claims.

Therefore, the foregoing is considered as illustrative only of the principles of the disclosure. Further, since numerous modifications and changes will readily occur to those skilled in the art, it is not desired to limit the invention to the exact construction and operation shown and described, and accordingly, all suitable modifications and equivalents may be resorted to, are deemed to fall within.

1) An apparatus for high heat testing of a remote radio head unit, the apparatus comprising:
a chamber comprised of at least one door and a plurality of walls creating an interior volume;
at least two vents attached to the chamber such that air can enter and exit the interior volume of the chamber;
a computer operably coupled to an apparatus system;
a thermometer secured within the chamber, wherein the thermometer is operably coupled to the computer via the apparatus system;
at least one fan secured to at least one of the vents; wherein each of the at least one fan is operably coupled to the computer via the apparatus system;
a plurality of electrical connections and a plurality of network connections are housed within the chamber.

2) The apparatus of claim 1 further comprising at least one latch secured to the door and at least one wall of the chamber.

3) The apparatus of claim 1 further comprising a control panel secured to the chamber;
wherein the control panel is operably coupled to the computer via the apparatus system.

4) The apparatus of claim 3 wherein the control panel includes at least one item selected from the group consisting of: a power button, a start button, a clock, a temperature display, and a plurality of lights.

5) The apparatus of claim 1 further comprising a screen secured to a wall of the chamber and operably coupled with the computer.

6) The apparatus of claim 1 further comprising a shelf located within the chamber.

7) The apparatus of claim 6 wherein the shelf has a plurality of apertures therethrough.

8) The apparatus of claim 6, wherein the shelf is secured to a bracket which allows the shelf to be partially removed from the chamber without being disconnected from the chamber.

9) The apparatus of claim 1 further comprising a door sensor operably coupled to the computer via the apparatus system, wherein the door sensor determines when the door is in an open position.

10) The apparatus of claim 1 wherein the plurality of electrical connections allow for a remote radio head unit to be operably coupled to the electrical connections and receive proper power.

11) The apparatus of claim 1 wherein the plurality of network connections allow for a remote radio head unit to be operably coupled to the computer via the apparatus system through the network connections.
